(19) United States
(12) Patent Application Publication
(10) Pub. No.: US 2022/0155952 A1
(43) Pub. Date: May 19, 2022

(54) ACCESSIBLE CHARGING DEVICE

(71) Applicant: Siemens Aktiengesellschaft, Muenchen (DE)

(72) Inventors: Pierre Wohlgemuth, Grosspoesna (DE); Steffen Stolze, Leipzig (DE); Joerg Sonntag, Leipzig (DE); Markus Karmazin, Buckenhof (DE)

(21) Appl. No.: 17/526,157

(22) Filed: Nov. 15, 2021

(30) Foreign Application Priority Data
Nov. 13, 2020 (DE) 10 2020 214 318.8

(51) Int. Cl. G06F 3/0488; G06F 3/0484; B60L 53/30

(52) U.S. Cl. CPC G06F 3/04886; B60L 53/305; G06F 3/04847

(57) ABSTRACT

A charging device for an electric vehicle includes a touch-sensitive screen and a control unit connected to the screen. The control unit is configured to detect an interaction of a user on the basis of a touch of the screen and to output a graphical user interface on the screen according to the detected interaction. The control unit is further configured to display the user interface on only a partial area of the screen and to variably choose a vertical distance between the partial area and a lower edge of the screen.

### CROSS-REFERENCE TO RELATED APPLICATION

This application claims the priority, under 35 U.S.C. § 119, of German Patent Application DE 10 2020 214 318.8, filed Nov. 13, 2020; the prior application is herewith incorporated by reference in its entirety.

### FIELD AND BACKGROUND OF THE INVENTION

The invention relates to a charging device for an electric vehicle.

Charging devices for electric vehicles are becoming increasingly widespread with the ongoing decarbonization of road traffic. Charging devices are intended not only to perform their fundamental technical task, but also to be simply and conveniently usable.

### SUMMARY OF THE INVENTION

It is accordingly an object of the invention to provide an improved accessible charging device, which overcomes the hereinafore-mentioned disadvantages of the heretofore-known devices of this general type and which is simply and conveniently usable.

With the foregoing and other objects in view there is provided, in accordance with the invention, a charging device for an electric vehicle having a touch-sensitive screen and a control unit connected to the screen which is configured to detect an interaction of a user on the basis of a touch of the screen and to output a graphical user interface on the screen according to the detected interaction. According to the invention, the control unit is further configured to display the user interface on only a partial area of the screen and to variably choose a vertical distance between the partial area and a lower edge of the screen.

The charging device according to the invention can therefore be comfortably controlled by a user by touching the touch-sensitive screen, wherein the control unit outputs a graphical user interface in response to these interactions of the user. The graphical user interface can display, for example, variable graphical and textual content in order to guide the user through the actual charging procedure or an authentication and a payment procedure, insofar as these steps are provided by the operator of the charging device. The graphical user interface can be provided with operating elements which can be actuated by touch at the location of the operating elements on the screen and the like, as is generally known in the field of graphical interfaces for devices with touch-sensitive screens. However, the charging device according to the invention is distinguished in that, in contrast to the prior art, the graphical user interface is displayed on only a partial area of the touch-sensitive screen. The screen area not used for the graphical user interface can, for example, remain blank or can be filled with a color, a color gradient, a static or animated background image or static or animated graphical pattern, wherein static content is preferred due to the lower risk of distraction of the user. As a result, in contrast to the widespread technical teaching of using the available screen area as completely as possible for a graphical user interface, the area of the screen to be perceived by a user and to be operated by touch is reduced to the (in particular rectangular) partial area, which is normally associated with a poorer perceptibility and increased costs for the unused screen area. The invention overcomes these preconceptions and exploits the reduction of the screen area used for the graphical user interface to the partial area of the screen for an increase in ease of use. In order to do this, the control unit of the charging device is configured to variably choose a vertical distance between the partial area and a lower edge of the screen. This means that, in the operation of the charging device, the partial area and the graphical user interface displayed therein can be disposed at different heights on the screen and therefore at different heights above the base around the charging device without the screen itself having to be movably or adjustably suspended. As a result, the charging device is configured to be easily usable by people of different heights or, for example, by wheelchair users as well, since the graphical user interface can be displayed for a relatively short or wheelchair-using user with no or a small vertical distance from the lower edge of the screen and for a relatively tall user with a larger vertical distance from the lower edge of the screen.

A vertical screen extension of the screen is preferably greater than a horizontal screen extension of the screen. A rectangular screen, for example, with conventional aspect ratios such as 16:9, etc., can be disposed in a portrait orientation on the charging device. The partial area particularly preferably has a rectangular form in this case which is disposed in a landscape orientation.

The partial area is advantageously exactly as wide as the screen. This means that, in such embodiments of the invention, areas of the screen not used for the display of the graphical user interface are located exclusively below and/or above the partial area used for the graphical user interface. As a result, the complete area of the screen located at least approximately at eye level of the respective user is advantageously used for the graphical user interface. No screen area that is comfortably perceptible to a respective user is thereby wasted. Generally speaking, a rectangular shape of the partial area is preferred, but other shapes are also possible.

The control unit of the charging device is particularly preferably configured to adjust the vertical distance according to the detected interaction of the user depending on the detected interaction. A user can thereby adjust the positioning of the graphical user interface according to his or her personal preferences. The graphical user interface can include, for example, operating elements which, when touched, move the partial area within the screen upwards or downwards. It is conceivable in principle to store this preference and to use it automatically in the future following an identification of the user, for example following an input of a unique ID (UID) of the user or of the electric vehicle.

The control unit can also be configured to identify a screen position of a touch of the touch-sensitive screen by the user and to adjust the vertical distance depending on the identified screen position. A welcome screen, for example, can be displayed centrally or over the whole area of the screen with a prompt to touch the screen in order to start the operating procedure. If a user touches the screen, the graphical user interface is displayed at a vertical distance from the lower edge of the screen in such a way that the partial area surrounds the screen position of the touch. It is assumed in this case that the height at which the user has touched the screen is within easy reach of the user.

The interaction can also include a movement of a finger on the screen (frequently referred to as a swipe, slide or sweep), wherein the control unit is configured to identify a direction of movement in order to adjust the vertical distance depending on the identified direction of movement. The user can thereby move the partial area on the screen used for displaying the graphical user interface, in particular steplessly.

However, the charging device can also be equipped with a sensor unit which is connected to the control unit and is configured to detect the user. The control unit is configured to adjust the vertical distance depending on a sensor signal of the sensor unit. The sensor unit can include, for example, a camera, an array of infrared sensors or the like with which the position of the eyes or the head of the user can be detected when approaching the charging device. As a result, the charging device can decide whether a relatively smaller or greater vertical distance for the positioning of the partial area will be comfortable for the user. Nevertheless, following the positioning performed automatically on the basis of the sensor signal, the partial area can additionally be positionable by the user, as described above.

The control unit can be configured to choose the vertical distance in a plurality of defined steps. Three steps, for example, can be provided (partial area at the lower end of the screen, partial area centrally and partial area at the upper end of the screen).

A screen area of the screen preferably corresponds to an integer multiple of the partial area. The partial area can correspond, for example, to one third of the screen area, which can advantageously be combined with the last-mentioned embodiment example of the invention.

Embodiments of the charging device according to the invention are preferred in which a lower edge of the screen is disposed at a maximum height of 112 centimeters and/or in which an upper edge of the screen is disposed above a minimum height of at least 150 centimeters.

Other features which are considered as characteristic for the invention are set forth in the appended claims.

Although the invention is illustrated and described herein as embodied in an accessible charging device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram showing a first embodiment example of a charging device according to the invention;

FIGS. 2A to 2C are diagrammatic, front-elevational views of a second embodiment example of a charging device according to the invention;

FIGS. 3A and 3B are front-elevational views of a third embodiment example of a charging device according to the invention; and

FIGS. 4A and 4B are front-elevational views of a fourth embodiment example of a charging device according to the invention.

### DETAILED DESCRIPTION OF THE INVENTION

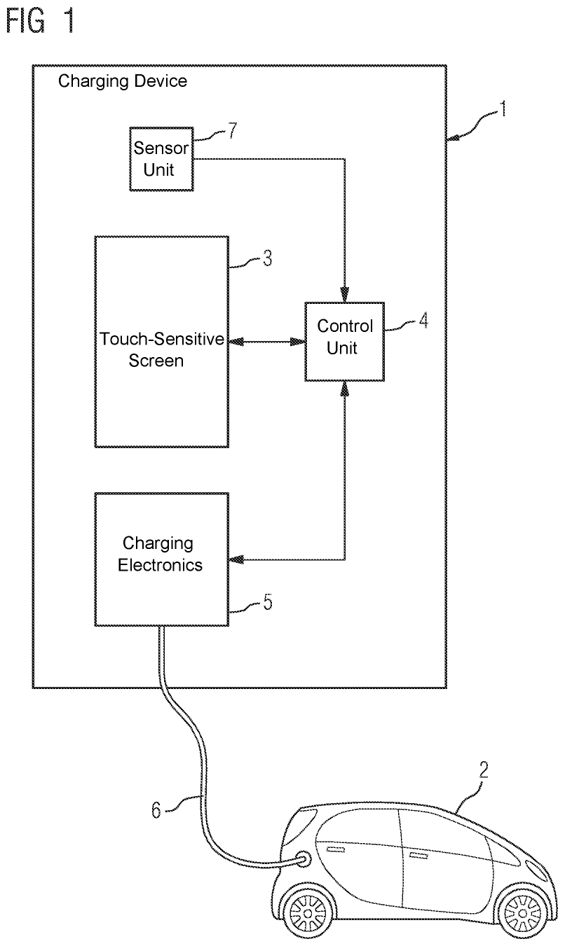

Referring now to the figures of the drawings in detail and first, particularly, to FIG. 1 thereof, there is seen a first embodiment example of a charging device 1 according to the invention which is shown in a block diagram. The charging device 1 has a touch-sensitive screen 3 which is disposed in this case in a portrait orientation on the charging device 1. The touch-sensitive screen 3 serves primarily to request a charging procedure for an electric vehicle 2 and, if necessary, to predefine some of its boundary conditions, such as a desired energy quantity, a charging power or charging speed or a cost limit. The charging device 1 can be controlled by a user by touching the touch-sensitive screen 3 and a graphical user interface displayed on the screen 3.

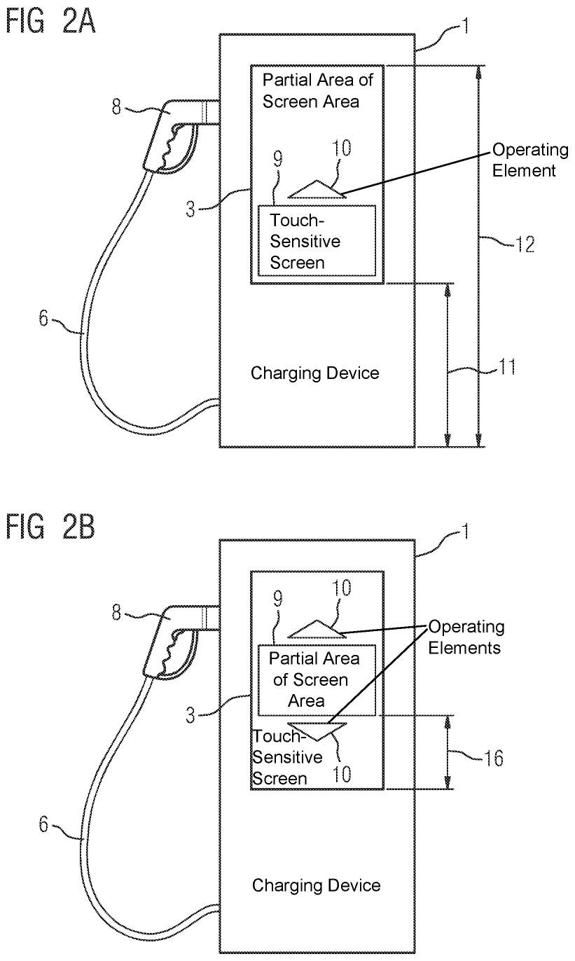

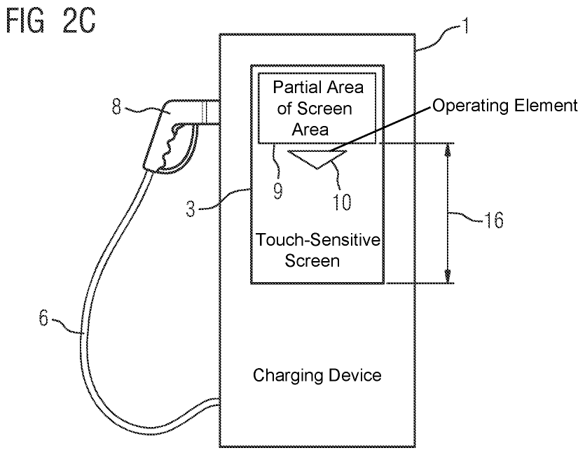

The touch-sensitive screen 3 is connected to a control unit 4 and transmits information to it relating to interactions of a user with the screen 3. The screen 3 further receives the screen content to be displayed on the screen 3 such as, in particular, the graphical user interface, from the control unit 4. The control unit 4 is further connected to charging electronics 5 which feed charging current to the electric vehicle 2 through a charging cable 6 and a charging plug 8 (FIGS. 2A to 4B) and controls the charging electronics for the performance of a charging procedure. The control unit 4 can substantially also be implemented as distributed among a plurality of interworking functional units.

In the embodiment example shown in FIG. 1, an optional sensor unit 7 is provided which is similarly connected to the control unit 4 and is configured to detect a user of the charging device 1 in order to provide information in this way relating to a presumed eye level of the user. On the basis of this information, the control unit of the charging device can choose a relatively small or great vertical distance in the positioning of the partial area which will be comfortable for the user.

FIGS. 2A to 2C show a second embodiment example of a charging device 1 according to the invention. The touch-sensitive screen 3 is disposed in a portrait orientation on the charging device 1 so that a lower edge of the screen 3 has a height 11 above the base and an upper edge of the screen 3 has a height 12 above the base. The height 11 can, for example, be up to 112 centimeters and the height 12 can be at least 150 centimeters.

A graphical user interface is displayed in a partial area 9 of the screen area of the screen 3. The partial area 9 is disposed in the three figures FIGS. 2A, 2B and 2C at different vertical distances 16 from the lower edge of the screen 3. In FIG. 2A, the vertical distance 16 is zero (no vertical distance), so that the partial area 9 with the graphical user interface is displayed at the lower end of the screen 3. This configuration of the partial area 9 is accessible to users of all anticipated body heights and positions, even if it is uncomfortable for a relatively tall person. Due to the substantial accessibility of the partial area 9, the positioning of the partial area 9 as shown in FIG. 2A can be used by all users, for example for a first screen content shown during an operating procedure, and can then be moved under the control of the user.

In FIG. 2B, the partial area 9 is disposed approximately or exactly centrally on the screen 3 so that the vertical distance 16 accordingly assumes an average value which corresponds in this case at least approximately to one third of the vertical screen extension. This positioning of the partial area 9 is therefore particularly suitable for displaying the graphical user interface for persons of average height. In FIG. 2C, the partial area is positioned at the upper end of the screen area of the screen 3 so that the maximum vertical distance 16 is chosen. This positioning of the partial area 9 is therefore particularly suitable for tall users.

In FIGS. 2A to 2C, operating elements 10 are further shown by way of example which are not part of the actual graphical user interface and which move the partial area 9 within the screen 3 in response to an activation by a user touching the screen 3 in the area of the operating elements 10. The operating elements 10 are shown herein merely by way of example in a stylized arrow shape, also indicating the direction in which the partial area 9 is moved when the respective operating element 10 is activated. A partial area 9 positioned as shown FIG. 2A can, for example, be moved upward and therefore into the positioning shown in FIG. 2B by touching the operating element 10 displayed on the screen 3. The partial area 9 disposed as shown in FIG. 2B can be moved back once more into the position shown in FIG. 2A by actuating the lower operating element 10 shown in FIG. 2B. Conversely, if the operating element 10 shown in FIG. 2B displayed above the partial area 9 is actuated, the partial area 9 can be moved from the position shown in FIG. 2B into the position shown in FIG. 2C. Since the partial area 9 in FIGS. 2A and 2C is positioned at the opposite ends of the screen 3, the respective operating element 10 is not displayed therein since the partial area 9 cannot be moved beyond the end of the screen 3.

In embodiments of the charging device 1 having a sensor unit 7, it can be provided that the control unit 4 performs a suitable positioning of the partial area 9 according to a sensor signal of the sensor unit 7 at least at the start of an operating procedure automatically adjusted to the user. A user can then, if necessary, subsequently modify the positioning of the partial area 9 manually according to his or her own preference.

In the above-described embodiments, a step-by-step movement of the partial area 9 is provided, but it is equally also possible to configure the partial area 9 as steplessly movable (pixel-by-pixel), which, on one hand, allows a better adjustability according to personal preferences of a user but which, on the other hand, can also be perceived as confusing.

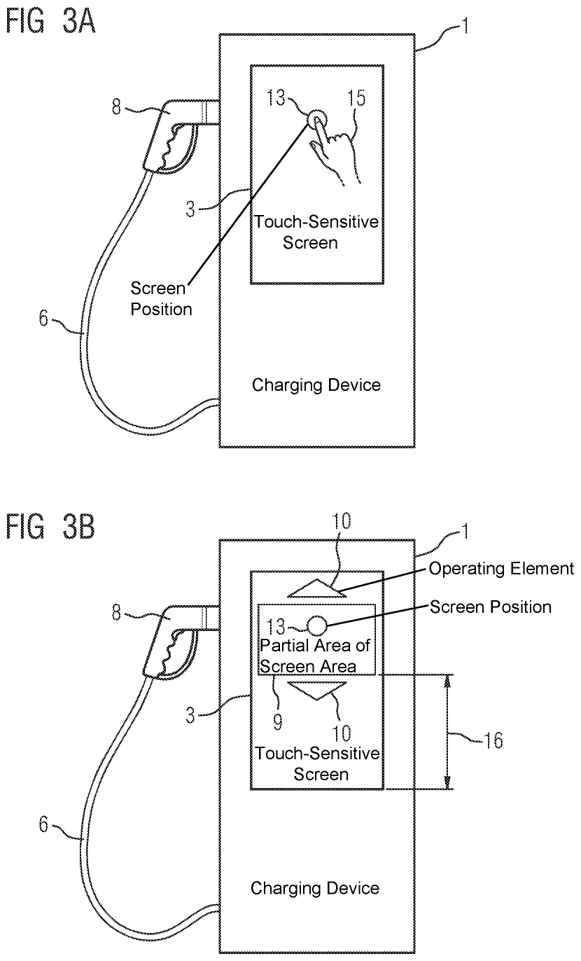

FIGS. 3A and 3B show a third embodiment example of a charging device 1 according to the invention. In FIG. 3A, a welcome screen is displayed which, along with a prompt to touch the screen 3 at any position, can also display further content such as advertising. In FIG. 3A, an area is further shown at a screen position 13 at which a hand 15 of a user touches the screen 3 in order to start an operating procedure of the charging device 1. The charging device 1 of the third embodiment example then shows the graphical user interface for starting the charging procedure in a partial area 9 which is disposed around the screen position 13, since the user can clearly reach the screen position 13. The user can furthermore optionally move the partial area 9 vertically within the screen area of the screen 3 through operating areas 10 if the positioning around the screen position 13 proves to be uncomfortable after all.

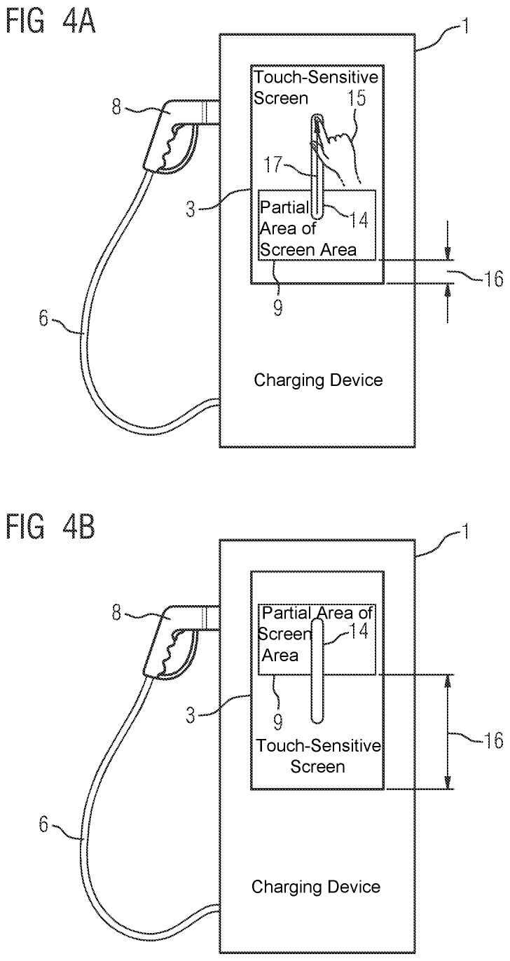

FIGS. 4A and 4B show a fourth embodiment example of a charging device 1 according to the invention. In FIG. 4A, the partial area 9 is disposed in the lower half of the screen 3. A user touches the screen 3 with his or her hand 15 (for example on an operating element (not shown) or on any part of the partial area 9) and draws the touching finger of the hand 15 along a direction of movement 17 over a coated area 14 of the touch-sensitive screen 3. As a result, the user moves the partial area 9 with the graphical user interface in the direction of movement 17 so that, when the finger is released as shown in FIG. 4B, it is positioned with a correspondingly increased vertical distance 16. If necessary, this process can be configured by the user to be repeatable as frequently as required.

All of the illustrated embodiments of the charging device 1 according to the invention offer the advantage that a graphical user interface for the operation of the charging device 1 is displayed at a height that is comfortable for a respective user. This advantage is achieved in that only a partial area 9 of the screen area of the screen 3 is used for displaying the graphical user interface, the positioning of that partial area at a vertical distance 16 from the lower edge of the screen 3 being configured as variable. Accessibility for wheelchair users, in particular, can thereby be achieved. A touchscreen having a 24-inch screen diagonal, for example, can be used as the screen 3, thus providing an adequately large screen area in order to enable a partial area 9 of adequate size.

The invention has been explained in detail with reference to illustrations of embodiment examples. The examples serve merely to provide a better understanding and are not intended to restrict the invention which is defined exclusively by the following patent claims.

The following is a summary list of reference numerals and the corresponding structure used in the above description of the invention.

### REFERENCE NUMBER LIST

1 Charging device
2 Electric vehicle
3 Touch-sensitive screen
4 Control unit
5 Charging electronics
6 Charging cable
7 Sensor unit
8 Charging plug
9 Partial area
10 Operating element
11 Height of lower edge of screen
12 Height of upper edge of screen
13 Screen position
14 Coated area
15 Hand
16 Vertical distance
17 Direction of movement

1. A charging device for an electric vehicle, the charging device comprising:
a touch-sensitive screen having a partial area and a lower edge; and
a control unit connected to said screen;
said control unit configured to detect an interaction of a user based on a touch of said screen and to output a graphical user interface on said screen according to the detected interaction; and
said control unit further configured to display the user interface on only said partial area of said screen and to variably choose a vertical distance between said partial area and said lower edge of said screen.

2. The charging device according to claim 1, wherein said screen has a horizontal screen extension and a vertical screen extension greater than said horizontal screen extension.

3. The charging device according to claim 1, wherein said partial area is exactly as wide as said screen.

4. The charging device according to claim 1, wherein said control unit is configured to adjust the vertical distance according to the detected interaction of the user depending on the detected interaction.

5. The charging device according to claim 4, wherein the interaction includes a touch of said screen, and said control unit is configured to identify a screen position of the touch and to adjust the vertical distance depending on the identified screen position.

6. The charging device according to claim 4, wherein the interaction includes a movement of a finger on said screen, and said control unit is configured to identify a direction of the movement and to adjust the vertical distance depending on the identified direction of movement.

7. The charging device according to claim 1, which further comprises a sensor unit connected to said control unit, said sensor unit configured to detect the user, and said control unit configured to adjust the vertical distance depending on a sensor signal of said sensor unit.

8. The charging device according to claim 1, wherein said control unit is configured to choose the vertical distance in a plurality of defined steps.

9. The charging device according to claim 1, wherein said screen includes a screen area corresponding to an integer multiple of said partial area.

10. The charging device according to claim 1, which further comprises:
a base of the charging device;
said screen having an upper edge; and
said screen being disposed with at least one of:
said lower edge at a maximum height of 112 centimeters above said base, or
said upper edge at a minimum height of 150 centimeters above said base.
